(19) United States
(12) Patent Application Publication
(10) Pub. No.: US 2008/0199151 A1
(43) Pub. Date: Aug. 21, 2008

(54) SYSTEM AND METHOD OF AVOIDING CONNECTION CHANGE WHILE RECORDING

(75) Inventors: Chad Andrew Lefevre, Indianapolis, IN (US); Mark Gilmore Mears, Zionsville, IN (US)

Correspondence Address: SHIMOKAJI & ASSOCIATES, P.C., 8911 RESEARCH DRIVE, IRVINE, CA, 92618, US

(73) Assignee: TTE TECHNOLOGY, INC., INDIANAPOLIS, IN (US)

(21) Appl. No.: 11/697,186

(22) Filed: Apr. 5, 2007

(30) Foreign Application Priority Data
Feb. 7, 2007 (CN) 200710073215.5

(51) Int. Cl. H04N 7/00

(52) U.S. Cl. 386/96

(57) ABSTRACT

A personal video recorder (PVR) may be designed to capture a recording source which matches the view source displayed on a television, thereby allowing a user to pause and rewind “live TV.” However, during recording, the user may inadvertently change the view source by, for example, accessing an autotune feature within a menu system of the audio/visual system. When this happens, the recording source may be prevented from tracking the view source, thereby allowing the continued recording of the program without loss or interruption while the menu system is active.

### CROSS-REFERENCE TO RELATED APPLICATIONS

This application claims foreign priority under 35 USC 119(a)-(d) to Chinese Patent Application 200710073215.5, filed on Feb. 7, 2007, the disclosure of which is herein incorporated by reference in its entirety.

### BACKGROUND OF THE INVENTION

The present invention relates to audio/visual content recording systems and methods, and more specifically, to systems and methods for the avoidance of loss of a specific recording source when certain menus change the displayed audio/visual content.

Conventional personal video recorders (PVRs, also known as digital video recorders, DVRs; audio/visual hard disk drives, AVHDDs; or hard disk recorders, HDRs) typically record and/or buffer the content which is displayed on a television (TV). This content may come from a TV tuner or may be connected to the TV over, for example, IEEE-1394. Such IEEE-1394 devices may include digital cable boxes, VCRs, DVD players and the like.

With conventional PVRs, the user can record the currently playing program, but the recording can get lost if the user changes the source of the recording. This is, in many cases, desirable so that the user may have the ability to pause and rewind the currently displayed program. However, there are some cases where the user could be changing menu options and accidentally change the source of the recording. In this case, the user may inadvertently lose their recording.

It may often be advantageous to have the view source the same as the recording source, especially when using a PVR. Such a configuration may allow pausing and rewinding of “live TV”. In other words, when the view source is the same as the recording source, the PVR may capture, for example, the previous 30 minutes of view source programming, thereby allowing the user to rewind and replay missed scenes. This is similar to how a Tivo™ device may operate.

Referring to FIG. 1, there is shown a flow chart 10 depicting conventional PVR operation. A user may be recording desired content onto a PVR at which time the user may change the view source in a step 12. This may be done by, for example, changing the channel on the TV. When the view source is changed, the recording source may be changed to match the view source in a step 14. In other words, the PVR, which was recording the first view source, is now recording the changed view source. The content of the first view source is no longer being captured by the PVR.

International patent publication WO2005/048595A1 (WO'595) discloses a television apparatus having digital serial bus ports which allows a user to select a user-designated digital video content source input such as a digital tuner of the television apparatus and digital serial bus compliant components connected to the television apparatus via the digital serial bus ports of the television apparatus, and to cause digital content from the user-designated digital content source device to be recorded onto a digital recording device connected to the television apparatus via the digital serial bus. The arrangement described in WO'595 may allow a user to continuously record digital content onto a digital recording device, whether from the TV's digital tuner or from another digital serial bus compliant device in a peer-to-peer arrangement. The WO'595 system, however, does not contemplate inadvertent changes in the selected digital content that is being recorded which may result, for example, by a user selecting certain programming menus of the television.

As can be seen, there is a need for a system and method for allowing the recording of digital content without inadvertently losing the digital source through, for example, accessing certain menus of the television.

### SUMMARY OF THE INVENTION

In one aspect of the present invention, an audio/visual system comprises a display device; a recording device; a view source capable of being displayed on the display device; and a recording source being sent to the recording device; wherein a change in the view source results in either a first condition or a second condition, the first condition being when the change is intentional and the second condition resulting when the change is inadvertent, and wherein the recording source matches the view source when in the first condition and the recording source is maintained to the view source prior to the change when in the second condition.

In another aspect of the present invention an audio/visual system comprises a television; a PVR connected to the television via a IEEE-1394 peer-to-peer connection; a view source adapted to be displayed on the television; a recording source adapted to be recorded by the PVR; and a menu system for programming the audio/visual system, wherein a change in the view source is either intentional or inadvertent, and wherein the recording source matches the view source when the change in the view source is intentional and the recording source is maintained to the view source before the change when the change in the view source is inadvertent.

According to a further aspect of the present invention, a method for the avoidance of changing a recording source when a view source is changed in an audio/visual system comprises determining if a user is in a menu system of the audio/visual system; changing the view source and allowing the recording source to remain unchanged if the user is in a menu system of the audio/visual system; and changing the recording source to match the view source if the user is not in a menu system of the audio/visual system.

These and other features, aspects and advantages of the present invention will become better understood with reference to the following drawings, description and claims.

### BRIEF DESCRIPTION OF THE DRAWINGS

FIG. 1 is a flow chart showing a conventional method of recording audio/visual content;

FIG. 2 is a block diagram showing a system according to one embodiment of the present invention; and

FIG. 3 is a flow chart showing a method of recording audio/visual content according to an embodiment of the present invention.

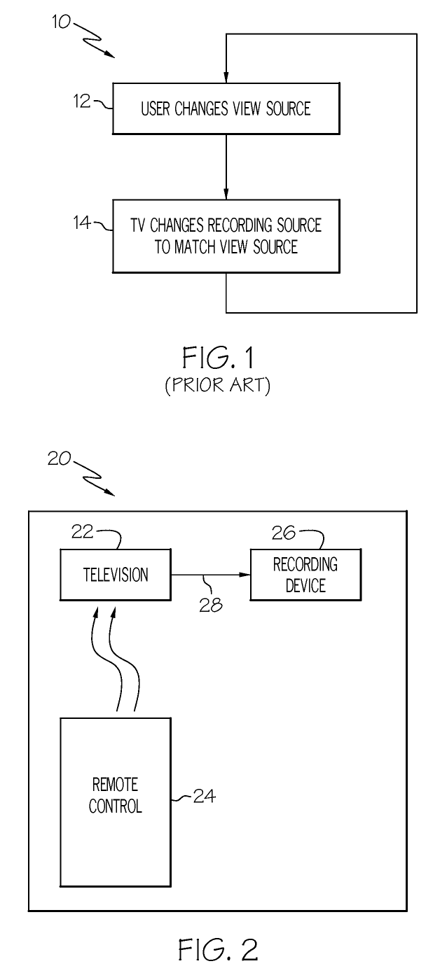

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The term “audio/visual system” as used herein includes components for receiving an audio/visual signal, such as a television tuner, a digital cable box, a terrestrial signal receiver or the like; a display device for viewing a program; and at least one recording device, such as a PVR. An audio/visual system may be part of a “home entertainment system” which may further include sound systems, music playing capabilities and the like.

The term “view source” as used herein refers to audio/visual data being transmitted to a display device, such as a television, for viewing on the display.

The term “recording source” as used herein refers to audio/visual data being transmitted to a recording device, such as a PVR.

The term “inadvertent change” as used herein in reference to a view source refers to an action by the user in which the user may change the view source without the realization and/or intention that the view source be changed. For example, when auto-tuning a VCR connected to an audio/visual system, the view source may inadvertently change when the VCR cycles through all television inputs to seek other devices (such as a DVD player, a TV tuner and the like) in the system.

Briefly, the present invention provides systems and methods for maintaining the source of a PVR recording, even while the user changes what is viewed for intended recording, for example, by selecting certain menu items on a television. In contrast to conventional PVR recordings in which the program that is being recorded may change if the user changes the source of the recording, the systems and methods of the present invention may maintain connection to a desired PVR recording source, even when the television display changes.

In accordance with the present invention, a change in the view source may result in either a first condition or a second condition, the first condition being when the change is intentional and the second condition resulting when the change is inadvertent. The recording source may stay the same as the view source when in the first condition (intentional change of the view source) and the recording source may be maintained to the view source before the change when in the second condition (inadvertent change of the view source). In other words, the present invention may allow the view source and the recording source to be different. As described in further detail below, when an auto-tune feature may be selected on a device (such as a VCR or a digital cable TV tuner) connected to the audio/visual system, the recording device may maintain recording from that same recording source, while the view source changes with the user operating the menu system. Once the user finishes the particular menu task, the view source may once again become the same as the recording source.

The present invention may be useful not only with PVR recordings, which are often saved on a hard disk drive (HDD), but may be useful for any recording device connected with the audio/visual system. For example, a VCR or a DVD recorder may be connected to the television for recording a particular program. Similar to the situation described above, wherein the recording source to a PVR may be inadvertently changed by the user (for example, by accessing certain menu systems), the recording source to the VCR or DVD recorder may also be inadvertently changed. The present invention includes systems and methods to prevent the change of the source of the recording if the user is recording while also, for example, changing menus.

Referring to FIG. 2, there is shown a block diagram of an audio/visual system 20 according to one embodiment of the present invention. A display device, such as a television 22, may be operated by a remote control 24. A recording device 26 may be connected to the television 22. In one embodiment of the present invention, the recording device 26 and the television 22 may be connected over an IEEE-1394 peer-to-peer connection 28. Alternatively, the television 22 and the recording device 26 may be connected via other conventional means, such as coax, RCA connections, fiber optics and the like. IEEE-1394 connections 28 are known in the art as described, for example, in U.S. Pat. Nos. 6,078,783 and 6,430,629, herein incorporated in their entirety by reference.

Additional devices (not shown) that may be included in the audio/visual system 20 could include a digital cable box, a sound system, a VCR, a DVD player/recorder, and the like.

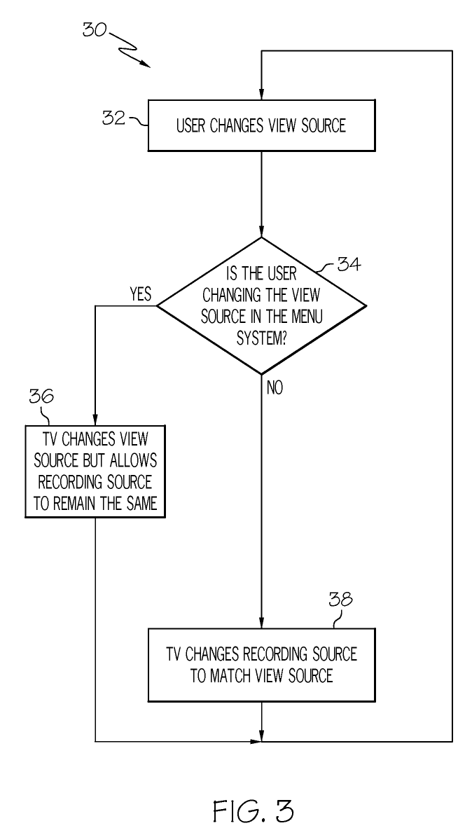

Referring now to FIG. 3, there is shown a method 30 according to an embodiment of the present invention. If the user is currently recording via the 1394 connection 28, for example, from a digital cable box to a PVR (HDD), and the user goes into the menus to, for example, change the source for VCR auto-tuning, the auto-tune task may cycle through all the television inputs to seek other devices (such as a DVD player, a TV tuner and the like) in the system 20. In a conventional system, this cycling through the inputs would change the view source for the television and, thus, also change the recording source for the PVR, causing loss or interruption of the user's recording. However, in the present invention, such loss or interruption is avoided.

In method 30, if the user changes the view source in step 32, a decision step 34 checks to see if the user is changing the view source in a menu system of one of the devices, such as a television, in the audio/visual system. If the user is changing the view source in a menu system of the television, the television may be programmed to change the view source as requested by the user but may maintain the connection (before the view source was changed) to the recording source in step 36. The manipulation of the recording source to either change to stay the same as the view source or to remain unchanged may be accomplished by programming in a manner similar to conventional methods which typically keep the view source and the recording source the same. Such programming would normally be within the capabilities of one having ordinary skill in the television software programming art. If the user is not in the menu system of one of the devices of the audio/visual system when the view source is changed, then the recording source may change to match the view source in step 38.

The view source could be a TV tuner and from which channels displayed on the TV may be changed (which, because menu systems are not accessed, the recording source may change to stay the same as the view source). The view source could be also be, for example, a DVD player. If, in either case, a user goes to the menu system and, for example, runs the auto-tune feature, with the TV tuner, this feature may look at all the TV's inputs so it knows which to keep active. It may look at 1394 inputs (for 1394 devices like a DVD) and it may look at all the channels available, often changing the view source as it cycles through each of the 1394 inputs. If a user was recording with a PVR, the data recorded would typically be the view source—which may result in the recording of this cycling through all the channels.

While the present invention has been described as allowing the view source and the recording source to differ when a user is accessing certain menu features, such as auto-tune, the present invention may include other scenarios in which the view source and the recording source may differ. For example, upon initial power-up, some IEEE-1394 devices may scan for other available devices and/or programming, resulting in a change in the view source. The present invention contemplates such a scenario and may prevent the recording source from changing in such a situation.

The systems and methods of the present invention may automatically cause the view source and recording source to differ in certain situations (such as the use of auto-tune as described above). Alternatively, the present invention may allow for user input to determine whether the view source will differ from the recording source. For example, when auto-tune is started and the view source is about to change, a message may appear on the TV, asking the user if they wish to maintain the recording source to keep the integrity of the recording currently in progress. Furthermore, the present invention may prevent the recording source from changing whenever a component of the audio/visual system is accessing a menu system.

It should be understood, of course, that the foregoing relates to exemplary embodiments of the invention and that modifications may be made without departing from the spirit and scope of the invention as set forth in the following claims.

We claim:

1. An audio/visual system comprising:
a display device;
a recording device;
a view source capable of being displayed on the display device; and
a recording source being sent to the recording device;
wherein a change in the view source results in either a first condition or a second condition, the first condition being when the change is intentional and the second condition resulting when the change is inadvertent, and
wherein the recording source matches the view source when in the first condition and the recording source is maintained to the view source prior to the change when in the second condition.

2. The audio/visual system according to claim 1, wherein the display device is a television.

3. The audio/visual system according to claim 1, wherein the recording device is a PVR.

4. The audio/visual system according to claim 1, wherein the recording source remains unchanged when the user accesses a menu system of any component in the audio/visual system.

5. The audio/visual system according to claim 1, wherein user input either keeps the recording source unchanged when the view source is inadvertently changed by the user or user input changes the recording source with the changed view source.

6. An audio/visual system comprising:
a television;
a PVR connected to the television via a IEEE-1394 peer-to-peer connection;
a view source adapted to be displayed on the television;
a recording source adapted to be recorded by the PVR; and
a menu system for programming the audio/visual system,
wherein a change in the view source is either intentional or inadvertent, and
wherein the recording source matches the view source when the change in the view source is intentional and the recording source is maintained to the view source before the change when the change in the view source is inadvertent.

7. The audio/visual system according to claim 6, wherein the certain areas of the menu system includes an autotune menu selection.

8. The audio/visual system according to claim 6, wherein the PVR is a hard disk drive-based storage device.

9. A method for the avoidance of changing a recording source when a view source is changed in an audio/visual system, the method comprising:
determining if a user is in a menu system of the audio/visual system;
changing the view source and allowing the recording source to remain unchanged if the user is in a menu system of the audio/visual system; and
changing the recording source to match the view source if the user is not in a menu system of the audio/visual system.

10. The method according to claim 9, wherein the audio/visual system comprises a television and a PVR connected to the television.

11. The method according to claim 10, wherein the television and PVR are connected over an IEEE-1394 peer-to-peer connection.

12. The method according to claim 11, further comprising allowing the user to choose between either allowing the recording source to remain unchanged or changing the recording source to match the view source when the user is in a menu system of the audio/visual system.
